(19) United States
(12) Patent Application Publication
(10) Pub. No.: US 2023/0177601 A1
(43) Pub. Date: Jun. 8, 2023

(54) SERVER DEVICE, TERMINAL DEVICE, INFORMATION PROCESSING PROGRAM, AND INFORMATION PROCESSING METHOD

(71) Applicant: SONY GROUP CORPORATION, TOKYO (JP)

(72) Inventors: YUSUKE SHIMIZU, TOKYO (JP); MASASHI MORI, TOKYO (JP); AYAKA NISHI, TOKYO (JP)

(21) Appl. No.: 17/906,630

(22) PCT Filed: Mar. 22, 2021
(86) PCT No.: PCT/JP2021/011566

§ 371 Date: Sep. 19, 2022

(30) Foreign Application Priority Data
Mar. 31, 2020 (JP) 2020-065187

(51) Int. Cl. G06Q 40/02; G06Q 40/08

(52) U.S. Cl. CPC G06Q 40/02; G06Q 40/08

(57) ABSTRACT

Provided are a server device, a terminal device, an information processing program, and an information processing method suitable for use in money lending and borrowing between people. A server device (10a) according to the present disclosure include a generation unit (100) that generates one or more pieces of interest rate information using a rating of a borrower as an individual, the rating being calculated on the basis of attribute information of the borrower, and a provision unit (107) that provides the one or more pieces of interest rate information to at least a second terminal device (30a, 30b) operated by a lender for the borrower out of a first terminal device (20a) operated by the borrower and the second terminal device, and provides interest rate information selected from among the one or more pieces of interest rate information in the second terminal device to a terminal device.

### TECHNICAL FIELD

The present disclosure relates to a server device, a terminal device, an information processing program, and an information processing method.

### BACKGROUND ART

There is known a technique of inputting and collecting an attribute of an individual and calculating a scoring value using machine learning with consideration given to credit information of a bank or a credit card company to reduce a time taken for a loan screening or credit check when a financial institution lends money to a customer or to reduce a default risk. Furthermore, there is known a technique of using a scoring value to determine whether or not a corporate loan can be made, to make simple settings of an applicable interest rate, and to make settings of an insurance premium of non-life insurance against a loss caused by default (for example, Patent Document 1).

### CITATION LIST

### Patent Document

Patent Document 1: Japanese Patent Application Laid-Open No.

### SUMMARY OF THE INVENTION

### Problems to be Solved by the Invention

It cannot be said, however, that such conventional techniques are sufficient because the techniques rely on high reliability of information used for scoring and are not designed to be applied to money lending and borrowing between individuals (peer to peer (P2P) lending).

It is therefore an object of the present disclosure to provide a server device, a terminal device, an information processing program, and an information processing method suitable for use in money lending and borrowing between individuals.

### Solutions to Problems

A server device according to the present disclosure include a generation unit that generates one or more pieces of interest rate information using a rating of a borrower as an individual, the rating being calculated on the basis of attribute information of the borrower, and a provision unit that provides the one or more pieces of interest rate information to at least a second terminal device operated by a lender for the borrower out of a first terminal device operated by the borrower and the second terminal device, and provides interest rate information selected from among the one or more pieces of interest rate information in the second terminal device to a terminal device.

### BRIEF DESCRIPTION OF DRAWINGS

FIG. 1 is a diagram schematically illustrating a configuration of an example of an information processing system applicable to an embodiment.

FIG. 2 is a functional block diagram of an example for describing a function of a server device applicable to the embodiment.

FIG. 3 is a functional block diagram of an example for describing a function of a terminal device according to the embodiment.

FIG. 4 is a block diagram illustrating a hardware configuration of an example of the server device applicable to the embodiment.

FIG. 5 is a block diagram illustrating a hardware configuration of an example of the terminal device applicable to the embodiment.

FIG. 6A is a schematic diagram for describing model creation processing performed in a learning unit according to the embodiment.

FIG. 6B is a schematic diagram for describing scoring processing performed in a scoring model unit according to the embodiment.

FIG. 7 is a sequence diagram of an example illustrating a flow of matching processing in P2P lending according to the embodiment.

FIG. 8 is a diagram schematically illustrating an example of an agreement screen displayed on a terminal device of a borrower.

FIG. 9 is a diagram schematically illustrating an example of a customer attribute input screen displayed on the terminal device of the borrower.

FIG. 10 is a diagram schematically illustrating an example of an amount and repayment period input screen displayed on the terminal device of the borrower.

FIG. 11 is a diagram schematically illustrating an example of a scoring screen displayed on the terminal device of the borrower.

FIG. 12 is a diagram schematically illustrating an example of how a rating is rounded.

FIG. 13 is a diagram schematically illustrating an example of a borrower confirmation screen displayed on a terminal device of a lender.

FIG. 14 is a diagram schematically illustrating an example of an interest rate selection screen displayed on the terminal device of the lender.

FIG. 15 is a diagram schematically illustrating an example of a standby screen displayed on the terminal device of the borrower side.

FIG. 16 is a diagram schematically illustrating an example of a chat screen showing chats between the borrower and the lender.

FIG. 17 is a diagram schematically illustrating an example of an interest rate information input screen displayed on the terminal device of the lender.

FIG. 18 is a diagram schematically illustrating an example of a lender selection screen displayed on the terminal device of the borrower.

FIG. 19 is a diagram schematically illustrating an example of a collateral input screen displayed on the terminal device of the borrower.

FIG. 20 is a diagram schematically illustrating an example of a collateral confirmation screen for confirming collateral presented to the borrower.

FIG. 21 is a diagram schematically illustrating an example of an insurance application determination screen for determining whether or not to apply insurance displayed on the terminal device of the lender.

FIG. 22 is a diagram schematically illustrating an example of an insurance selection screen for selecting insurance displayed on the terminal device of the lender.

FIG. 23 is a diagram schematically illustrating an example of an insurance detail display screen displayed on the terminal device of the lender.

FIG. 24 is a functional block diagram of an example for describing a function of a server device according to a modification of the embodiment.

FIG. 25 is a functional block diagram of an example for describing a function of a terminal device according to the modification of the embodiment.

### MODE FOR CARRYING OUT THE INVENTION

Hereinafter, an embodiment of the present disclosure will be described in detail with reference to the drawings. Note that, in the following embodiment, the same parts are denoted by the same reference numerals to avoid the description from being redundant.

Hereinafter, the embodiment of the present disclosure will be described in the following order.

1. Embodiment

1-1. System applicable to embodiment

1-1-1. System overview

1-1-2. Function of server device

1-1-3. Function of terminal device

1-1-4. Hardware configuration example

1-2. Scoring processing according to embodiment

1-3. Specific description of processing operation according to embodiment

2. Modification of embodiment

### 1. Embodiment

An information processing system according to an embodiment relates to peer to peer (P2P) lending that is the practice of matching an individual (borrower) who needs a fund with an individual (lender) who provides the fund over the Internet without going through a financial institution such as a bank. The information processing system performs scoring on the borrower using a customer scoring model configured on the basis of machine learning using attribute information of a plurality of borrowers to calculate a rating of the borrower, and performs the matching in P2P lending according to the embodiment on the basis of the rating thus calculated.

More specifically, the information processing system presents the rating calculated on the basis of the attribute information of the borrower to the lender side that lends out money (hereinafter, simply referred to as “loan”) to the borrower, for example. The lender side determines an interest rate that is applied to the loan to the borrower on the basis of the rating thus presented, and presents the interest rate thus determined to the borrower. The borrower side can determine whether or not to accept, from the lender side, the loan at the interest rate presented by the lender. This makes it possible to reduce a risk in P2P lending for the lender side and the borrower side.

Furthermore, the information processing system according to the embodiment can request the borrower side to present collateral. As the collateral, electronic information such as an e-mail address is used, and it is required that the number of pieces of collateral according to the rating of the borrower be presented, for example. The lender side may determine whether or not to make the loan to the borrower according to the collateral presented by the borrower side. Moreover, the information processing system according to the embodiment can present one or more types of insurance to the lender side according to the rating of the borrower side after concluding a contract with the borrower side, for example.

As described above, setting the interest rate, the collateral, and the insurance according to the rating of the borrower makes it possible to further reduce the risk in P2P lending for the lender side. This further allows matching between the borrower and the lender to be performed more easily.

(1-1. System Applicable to Embodiment)

(1-1-1. System Overview)

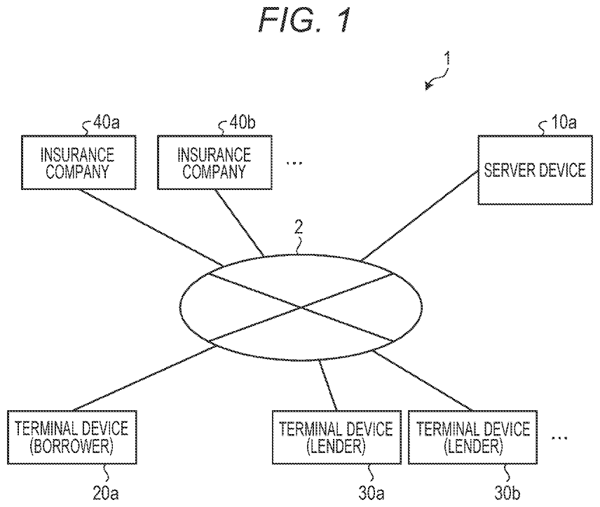

First, an information processing system applicable to the embodiment will be described. FIG. 1 is a diagram schematically illustrating a configuration of an example of the information processing system applicable to the embodiment. In FIG. 1, the information processing system 1 includes a server device 10a, a terminal device 20a, and terminal devices 30a, 30b, . . . , each of which is connected to a network 2 such as the Internet. Furthermore, insurance companies 40a, 40 b, . . . are connected to the network 2.

In FIG. 1, the terminal device 20a is a terminal device operated by a user of the borrower side. On the other hand, the terminal devices 30a, 30b, . . . are terminal devices operated by users of the lender side. Here, as each of the terminal device 20a and the terminal devices 30a, 30b, . . . , a mobile terminal such as a multifunctional mobile phone terminal (hereinafter, a smartphone) or a tablet computer is applicable. Alternatively, as each of the terminal device 20a and the terminal devices 30a, 30b, . . . , a desktop computer or an information processing device designed specifically for the information processing system 1 may be applied.

Note that, in the example illustrated in FIG. 1, only one terminal device 20a is illustrated as a terminal device of the borrower side, but two or more terminal devices 20a of the borrower side may be connected to the network 2.

The server device 10a communicates with the terminal device 20a and the terminal devices 30a, 30b, . . . over the network 2 to provide, to the terminal device 20a and the terminal devices 30a, 30b, . . . , services implemented by the information processing system according to the embodiment.

For example, the server device 10a configures a customer scoring model on the basis of machine learning using attribute information of a plurality of borrowers. The server device 10a performs scoring on attribute information of a corresponding borrower, the attribute information being transmitted from the terminal device 20a of the borrower side, on the basis of the customer scoring model to calculate a rating of the borrower. Furthermore, the server device 10a generates interest rate information indicating an interest rate using the rating thus calculated. The interest rate information generated by the server device 10a indicates, for example, a ratio to the amount of borrowing. The server device 10a can transmit the calculated rating to the terminal device 20a of the borrower side or the terminal devices 30a, 30b, . . . of the lender side to provide the rating to the terminal devices 20a, 30a, 30b, . . . . Furthermore, the server device 10a can transmit the interest rate information generated using the rating to the terminal devices 30a, 30b, . . . of the lender side to provide the interest rate information to the terminal devices 30a, 30b, . . . .

The terminal device 20a of the borrower side communicates with the server device 10a over the network 2 to transmit the attribute information of the borrower side to the server device 10a. Furthermore, the terminal device 20a receives the rating calculated by the server device 10a on the basis of the transmitted attribute information and transmitted from the server device 10a over the network 2. Moreover, the terminal device 20a receives the interest rate information indicating an interest rate presented by terminal devices 30a, 30b, . . . of the lender side (to be described later) from the server device 10a over the network 2. For example, the borrower may select, on the basis of the received interest rate information, a lender from which a loan is received from among a plurality of lenders, for example. Note that the interest rate information may be information indicating a ratio (percentage) to the amount of borrowing, or, in a case where the amount of borrowing is known, the interest rate information may be information indicating an amount of interest calculated from the amount of borrowing. The interest rate or the amount of interest is determined on the basis of the interest rate information.

The terminal devices 30a, 30b, . . . of the lender side are operated by different lenders A, B, . . . , respectively, for example. With the terminal device 30a operated by the lender A described as a representative of the plurality of terminal devices 30a, 30b, . . . , the terminal device 30a can receive, from the server device 10a, the rating calculated for the borrower and the interest rate information generated using the rating and set the interest rate on the basis of the rating and interest rate information thus received. The terminal device 30a can provide the interest rate set on the basis of the interest rate information to preset the interest rate to the borrower. At this time, the lender A can also perform, for example, chat-based communications with the borrower using the terminal device 30a and set, through the communications, the interest rate to be imposed on the borrower.

Note that the server device 10a can request the borrower to present collateral. In a case where collateral information indicating collateral input to the terminal device 20a of the borrower side indicates valid collateral, the server device 10a transmits the collateral information to the terminal device 30a of the lender A. The lender A can also determine whether or not to make a loan to the borrower on the basis of the collateral information.

Moreover, the server device 10a can be connected to systems of the insurance companies 40a, 40b, . . . , for example, over the network 2 to acquire information regarding an insurance contract from each of the insurance companies 40a, 40b, . . . . The server device 10a can transmit, to the terminal device 30a of the lender A, information indicating one or more insurance contracts according to the rating of the borrower among insurance contracts provided by each of the insurance companies 40a, 40b, . . . to the terminal device 30a of the lender A who has concluded a loan contract with the borrower.

Note that, in FIG. 1, the server device 10a is illustrated as being configured with a single information processing device, but the configuration is not limited to this example. For example, the server device 10a may be configured with cloud computing including a plurality of information processing devices and storage devices connected to each other over a network.

(1-1-2. Function of Server Device)

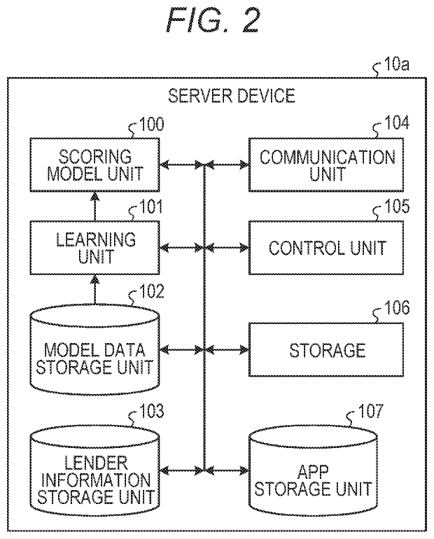

Next, a function of the server device 10a applicable to the embodiment will be described. FIG. 2 is a functional block diagram of an example for describing the function of the server device 10a applicable to the embodiment.

In FIG. 2, the server device 10a includes a scoring model unit 100, a learning unit 101, a model data storage unit 102, a lender information storage unit 103, a communication unit 104, a control unit 105, a storage 106, and an app storage unit 107.

The control unit 105 controls the overall operation of the server device 10a. The communication unit 104 performs communications over the network 2 under the control of the control unit 105. The storage 106 controls reading and writing of data from and to a memory (not illustrated).

The model data storage unit 102 stores model data used for the learning unit 101 to perform machine learning. The learning unit 101 performs machine learning using the data stored in the model data storage unit 102 to create a customer scoring model for calculating a rating according to the embodiment. The scoring model unit 100 stores the customer scoring model created by the learning unit 101. The scoring model unit 100 calculates a rating (score) of the borrower on the basis of attribute information of the borrower transmitted from the terminal device 20a of the borrower. Moreover, the scoring model unit 100 can generate interest rate information using the rating thus calculated. The scoring model unit 100 may generate the interest rate information using the customer scoring model, or may separately generate the interest rate information in accordance with a predetermined algorithm. Details of the machine learning and the creation of the customer scoring model by the learning unit 101 will be described later.

The lender information storage unit 103 stores information of a lender registered in the information processing system 1. For example, the lender transmits information of the lender from a terminal device (for example, the terminal device 30a) connected to the network 2 to the server device 10a over the network 2. The information of the lender includes, for example, identification information for identifying the lender, and may further include detailed information of the lender. The detailed information of the lender may include, for example, personal information of the lender, such as the lender's name, address, and contact address (e.g., email address).

For example, the lender A who desires to participate in P2P lending implemented by the information processing system 1 accesses the server device 10a from the terminal device 30a operated by the lender A over the network 2 and sets identification information to create an account for the information processing system 1. The lender A further transmits detailed information of the lender A from the terminal device 30a to the server device 10a. The server device 10a stores, into the lender information storage unit 103, the account information of the lender A and the detailed information of the lender A with the account information and the detailed information associated with each other to register the lender A in the information processing system 1. After being registered in the information processing system 1 as described above, the lender A can participate in P2P lending according to the embodiment.

The app storage unit 107 stores an application program (hereinafter, abbreviated as app) that runs on the terminal device 20a of the borrower or the terminal devices 30a, 30b, . . . of the lenders A, B, . . . . The P2P lending according to the embodiment is implemented by the app stored in the app storage unit 107, the app being downloaded to the terminal device 20a or the terminal devices 30a, 30b, . . . , for example, over the network 2 and installed and executed on the terminal device 20a or each of the terminal devices 30a, 30b, . . . .

At this time, the app downloaded, installed, and executed on the terminal device 20a and the terminal devices 30a, 30b, . . . can present the rating and the interest rate information calculated by the scoring model unit 100 in the server device 10a to at least the terminal devices 30a, 30b, . . . of the lenders participating in P2P lending to the borrower among the terminal device 20a, and the terminal devices 30a, 30b, . . . . That is, the app storage unit 107 functions as a provision unit that provides the rating and the interest rate information to at least the terminal devices 30a, 30b, . . . of lenders participating in P2P lending to the borrower among the terminal device 20a, and the terminal devices 30a, 30b, . . . .

Note that the app may be a program different between the terminal device 20a of the borrower side and the terminal devices 30a, 30b, . . . of the lender side, or may be a program that is common to the terminal device 20a of the borrower side and the terminal devices 30a, 30b, . . . of the lender side and be used separately in terms of function between the borrower side and the lender side. Furthermore, the app storage unit 107 need not be included in the server device 10a, and may be included, for example, in a system owned by a business operator that provides the app to the terminal device 20a or the terminal devices 30a, 30b, . . . . In this case, a part corresponding to the app storage unit 107 in the system owned by the business operator can be considered as a part of the information processing system according to the embodiment. That is, functions for the information processing system according to the embodiment implemented by the terminal device 20a of the borrower side and the terminal devices 30a, 30b, . . . of the lender side are provided by the information processing system.

(1-1-3. Function of Terminal Device)

Next, the functions of the terminal devices 20a, 30a, 30b, . . . according to the embodiment will be described. Note that the function of the terminal devices 30a, 30b, . . . of the lender A, B, . . . side is equivalent to the function of the terminal device 20a of the borrower side, so that the function of the terminal device 20a will be described here as a representative of the functions of the terminal devices 20a, 30a, 30b, . . . .

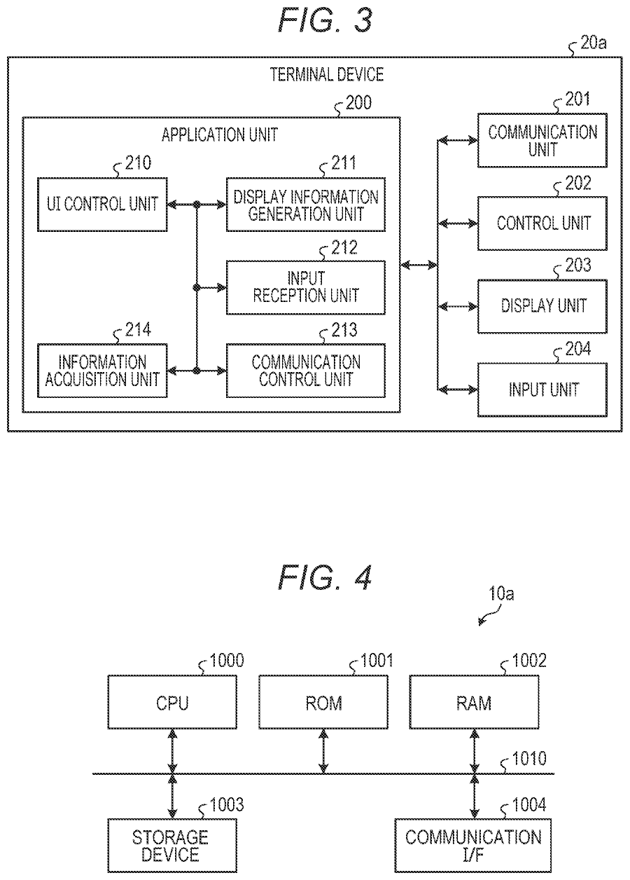

FIG. 3 is a functional block diagram of an example for describing the function of the terminal device 20a according to the embodiment. In FIG. 3, the terminal device 20a includes an application unit 200, a communication unit 201, a control unit 202, a display unit 203, and an input unit 204.

The application unit 200 further includes a user interface (UI) control unit 210, a display information generation unit 211, an input reception unit 212, a communication control unit 213, and an information acquisition unit 214.

The control unit 202 controls the overall operation of the terminal device 20a. The communication unit 201 communicates with the network 2 under the control of the control unit 202. The display unit 203 generates a display signal displayable by a display device on the basis of a display control signal. The input unit 204 generates a control signal in response to a user operation performed on an input device.

In the application unit 200, the UI control unit 210 controls display and input according to the embodiment in the terminal device 20a. The display information generation unit 211 generates the display control signal for displaying a screen on the display device under the control of the UI control unit 210. The input reception unit 212 receives user input on the basis of the control signal generated by the input unit 204. The communication control unit 213 controls the communication unit 201 to acquire display information for the display information generation unit 211 to generate the display signal over the network 2, and transmits input information received by the input reception unit 212 to the network 2. The information acquisition unit 214 acquires information held in the terminal device 20a on which the application unit 200 is installed.

(1-1-4. Hardware Configuration Example)

Next, hardware configuration examples of the server device 10a and the terminal devices 20a, 30a, 30b, . . . applicable to the embodiment will be described.

FIG. 4 is a block diagram illustrating a hardware configuration of an example of the server device 10a applicable to the embodiment. In FIG. 4, the server device 10a includes a CPU 1000, a read only memory (ROM) 1001, a random access memory (RAM) 1002, a storage device 1003, and a communication I/F 1004 that are communicatively connected to each other over a bus 1010.

The storage device 1003 is a non-volatile storage medium such as a hard disk drive or a flash memory. The storage device 1003 stores various programs and data for bringing the CPU 1000 into operation.

The CPU 1000 operates in accordance with an information processing program prestored in the ROM 1001 and the storage device 1003 to control the overall operation of the server device 10a. The communication I/F 1004 performs communications over the network 2 under the control of the CPU 1000.

Among the scoring model unit 100, the learning unit 101, the model data storage unit 102, the lender information storage unit 103, the communication unit 104, the control unit 105, the storage 106, and the app storage unit 107 described above, the communication unit 104, the control unit 105, and the storage 106 are implemented by, for example, a basic program (for example, an operating system (OS)) of the server device 10a running on the CPU 1000, the basic program being prestored in the storage device 1003. Furthermore, among such units, the scoring model unit 100, the learning unit 101, the model data storage unit 102, the lender information storage unit 103, and the app storage unit 107 are implemented by, for example, the information processing program for the server function executed on the CPU 1000.

The configuration is not limited to this example, and some or all of the scoring model unit 100, the learning unit 101, the model data storage unit 102, the lender information storage unit 103, the communication unit 104, the control unit 105, the storage 106, and the app storage unit 107 may be configured with hardware circuits that operate in cooperation with each other.

The information processing program has a module configuration including, for example, the scoring model unit 100, the learning unit 101, the model data storage unit 102, the lender information storage unit 103, and the app storage unit 107. From the viewpoint of physical hardware, for example, when the CPU 1000 reads the information processing program from a storage medium such as the storage device 1003 and executes the information processing program, the above-described units are each loaded onto a primary storage device such as the RAM 1002 and generated on the primary storage device.

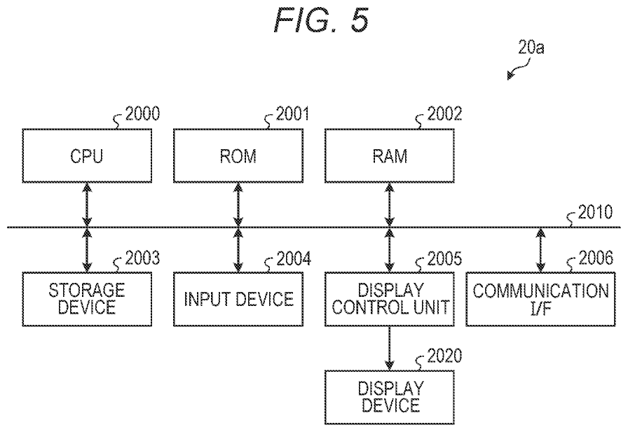

FIG. 5 is a block diagram illustrating a hardware configuration of an example of the terminal device 20a applicable to the embodiment. Note that the same configuration as the configuration of the terminal device 20a is applicable to the terminal devices 30a, 30b, . . . , so that the terminal device 20a will be described here as a representative of the terminal devices 20a, 30a, 30b, . . . .

In FIG. 5, the terminal device 20a includes a CPU 2000, a ROM 2001, a RAM 2002, a storage device 2003, an input device 2004, a display control unit 2005, and a communication I/F 2006 that are communicatively connected to each other over a bus 2010. Furthermore, in the example illustrated in FIG. 5, the terminal device 20a further includes a display device 2020 connected to the display control unit 2005.

The storage device 2003 is a non-volatile storage medium such as a hard disk drive or a flash memory. The storage device 2003 stores various programs and data for bringing the CPU 2000 into operation.

The CPU 2000 operates in accordance with a program prestored in the ROM 2001 and the storage device 2003 to control the overall operation of the terminal device 20a. Furthermore, the CPU 2000 forms the application unit 200 in accordance with, for example, an application program stored in the storage device 2003. The communication I/F 2006 performs communications over the network 2 under the control of the CPU 2000.

The input device 2004 generates a control signal in response to a user operation. The control signal thus generated is passed to the CPU 2000 over the bus 2010. The display control unit 2005 generates a display signal displayable by the display device 2020 on the basis of a display control signal generated by the CPU 2000 in accordance with a program, and outputs the display signal to the display device 2020. As the display device 2020, for example, a display device using a liquid crystal display (LCD) or organic electro-luminescence (EL) is applicable.

Here, for example, with the input device 2004 configured to generate a control signal according to a contact position and transmit light, the input device 2004 and the display device 2020 may be integrally formed to configure a touchscreen.

Among the application unit 200, the communication unit 201, the control unit 202, the display unit 203, and the input unit 204 described above, the communication unit 201, the control unit 202, the display unit 203, and the input unit 204 are implemented by, for example, a basic program (for example, an OS) of the terminal device 20a running on the CPU 2000. Furthermore, among such units, the application unit 200 is implemented by, for example, an app running on the CPU 2000, the app being acquired from the app storage unit 107 of the server device 10a. The configuration is not limited to this example, and some or all of the application unit 200, the communication unit 201, the control unit 202, the display unit 203, and the input unit 204 may be configured with hardware circuits that operate in cooperation with each other.

The app (application program) for forming the application unit 200 applicable to the embodiment has a module configuration including, for example, the UI control unit 210, the display information generation unit 211, the input reception unit 212, the communication control unit 213, and the information acquisition unit 214. From the viewpoint of physical hardware, for example, when the CPU 2000 reads the app from a storage medium such as the storage device 2003 and executes the app, the above-described units are each loaded onto a primary storage device such as the RAM 2002 and generated on the primary storage device.

(1-2. Scoring Processing According to Embodiment)

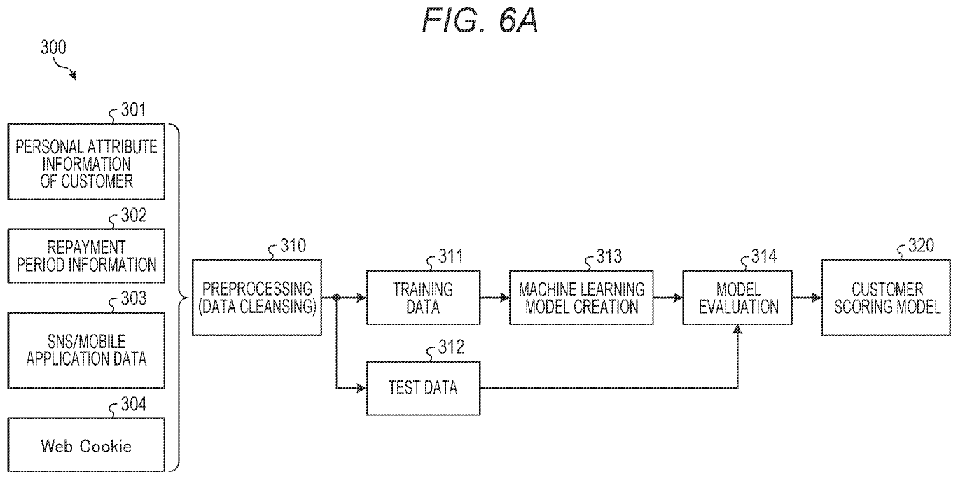

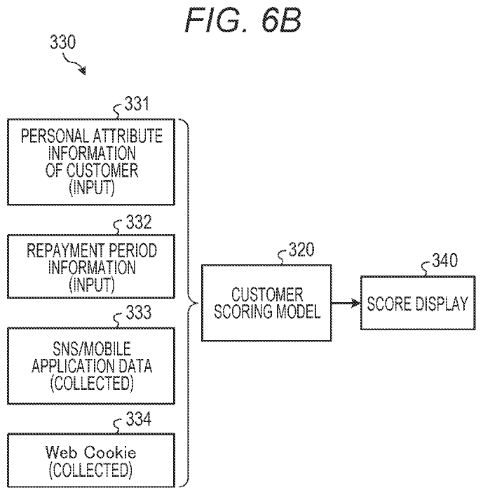

Next, scoring processing according to the embodiment will be described. FIG. 6A is a schematic diagram for describing model creation processing performed in the learning unit 101 according to the embodiment. The learning unit 101 acquires attribute information 300 regarding the borrower, and subjects the attribute information 300 thus acquired to preprocessing (data cleansing) 310. Here, the information processing system 1 collects the attribute information 300 from a large number of borrowers by a predetermined method, and subjects each of the plurality of pieces of attribute information 300 thus collected to the preprocessing 310.

In the example illustrated in FIG. 6A, the attribute information 300 regarding the borrower includes personal attribute information 301 of the borrower (customer), repayment period information 302 indicating a repayment period in which the borrower repaid borrowed money in the past, social networking service (SNS)/mobile application data 303 used by the borrower, and a Web cookie 304 stored in a Web browser used by the borrower.

The personal attribute information 301 of the borrower may include, for example, a name, an address, a contact address, information indicating a workplace (a trade name or the like in a case of a self-owned business), and a length of service (a length of business operation in a case of a self-owned business) of the borrower. Alternatively, the personal attribute information 301 may further include other information regarding the borrower as an individual.

The learning unit 101 splits each piece of attribute information 300 subjected to the preprocessing 310 into training data 311 and test data 312. The processing of splitting each piece of attribute information 300 into the training data 311 and the test data 312 is manually performed by a person, for example. The learning unit 101 performs machine learning using the training data 311 to create a model (machine learning model creation 313). The model thus created is evaluated on the test data 312 used as ground truth data (model evaluation 314), and a customer scoring model 320 is created on the basis of the evaluation result.

Note that, in a case where the customer scoring model 320 has been already created, the customer scoring model 320 is updated on the basis of newly acquired attribute information 300.

The created customer scoring model 320 is held in the scoring model unit 100.

FIG. 6B is a schematic diagram for describing scoring processing performed in the scoring model unit 100 according to the embodiment. For example, the terminal device 20a of the borrower who desires to use P2P lending implemented by the information processing system 1 according to the embodiment collects attribute information 330 of the borrower. In FIG. 6B, the attribute information 330 corresponds to the attribute information 300 described above. Personal attribute information 331, repayment period information 332, SNS/mobile application data 333, and a Web cookie 334 included in the attribute information 330 correspond to the personal attribute information 301, the repayment period information 302, the SNS/mobile application data 303, and the Web cookie 304 included in the attribute information 300 described above, respectively.

For example, the application unit 200 installed on the terminal device 20a causes the display device 2020 of the terminal device 20a to display a user interface (input and display screen) prompting input of the personal attribute information 331 and the repayment period information 332. The application unit 200 acquires the personal attribute information 331 and the repayment period information 332 input according to the user interface.

The SNS/mobile application data 333 is data stored in the terminal device 20a used by the borrower, and is acquired from the terminal device 20a by the information acquisition unit 214 of the application unit 200 installed on the terminal device 20a, for example. For example, the information acquisition unit 214 can acquire, in cooperation with an SNS app installed on the terminal device 20a, a posted comment or a friend list on a corresponding SNS as the SNS/mobile application data 333.

The application unit 200 can cause the information acquisition unit 214 to further acquire information held in the terminal device 20a (for example, a telephone number, a contact list, and location information data) as the SNS/mobile application data 333. Furthermore, the application unit 200 can cause the information acquisition unit 214 to acquire the Web cookie 334 from the Web browser installed on the terminal device 20a. The Web cookie 334 includes, for example, a Web browsing history held in the Web browser.

The information acquisition unit 214 acquires such data held in the terminal device 20a after receiving prior approval from the borrower.

The application unit 200 transmits, to the server device 10a, the personal attribute information 331, the repayment period information 332, the SNS/mobile application data 333, and the Web cookie 334 acquired from the terminal device 20a.

A description of an example where the application unit 200 acquires the attribute information 330 has been described above, but the configuration is not limited to this example. For example, an application program specialized in acquiring the attribute information 330 may be installed on the terminal device 20a. Furthermore, the attribute information 330 may further include information other than each piece of the information described above.

Furthermore, the application unit 200 installed on the terminal device 20a of the borrower may acquire the personal attribute information 301, the repayment period information 302, the SNS/mobile application data 303, and the Web cookie 304 included in the attribute information 300 used in the model creation processing described with reference to FIG. 6A in a similar manner to the personal attribute information 331, the repayment period information 332, the SNS/mobile application data 333, and the Web cookie 334.

Note that a description has been given of an example where the attribute information 330 transmitted to the server device 10a includes the personal attribute information 301, the repayment period information 302, the SNS/mobile application data 303, and the Web cookie 304, but the configuration is not limited to this example. For example, the attribute information 330 transmitted to the server device 10a may include at least one piece of information that makes the borrower identifiable. Here, the larger the number of pieces of information included as the attribute information 330 is, the higher the possibility that a high rating can be obtained.

The server device 10a receives the attribute information 330 transmitted from the terminal device 20a, and passes the attribute information 330 thus received to the scoring model unit 100. The scoring model unit 100 performs scoring on the attribute information 330 using the customer scoring model 320 created by the learning unit 101 described with reference to FIG. 6A to calculate a score (rating) of the attribute information 330.

Moreover, the scoring model unit 100 can generate, as described above, interest rate information using the rating thus calculated. The scoring model unit 100 may generate the interest rate information using the customer scoring model, or may separately generate the interest rate information in accordance with a predetermined algorithm.

As described above, the scoring model unit 100 according to the embodiment functions as a generation unit that calculates a rating of the borrower as an individual on the basis of the attribute information of the borrower and the model created by means of machine learning using a plurality of pieces of attribute information and generates interest rate information using the rating thus calculated.

In the example illustrated in FIG. 6B, the server device 10a performs processing of displaying the calculated score (rating) (score display 340). The server device 10a can transmit the calculated score (rating) to, for example, the terminal devices 20a, 30a, 30b, . . . and cause the terminal devices 20a, 30a, 30b, . . . to display the score (rating). Display examples of the score (rating) on the terminal devices 20a, 30a, 30b, . . . will be described later.

(1-3. Specific Description of Operation According to Embodiment)

Next, how the information processing system 1 operate to implement P2P lending according to the embodiment will be described more specifically.

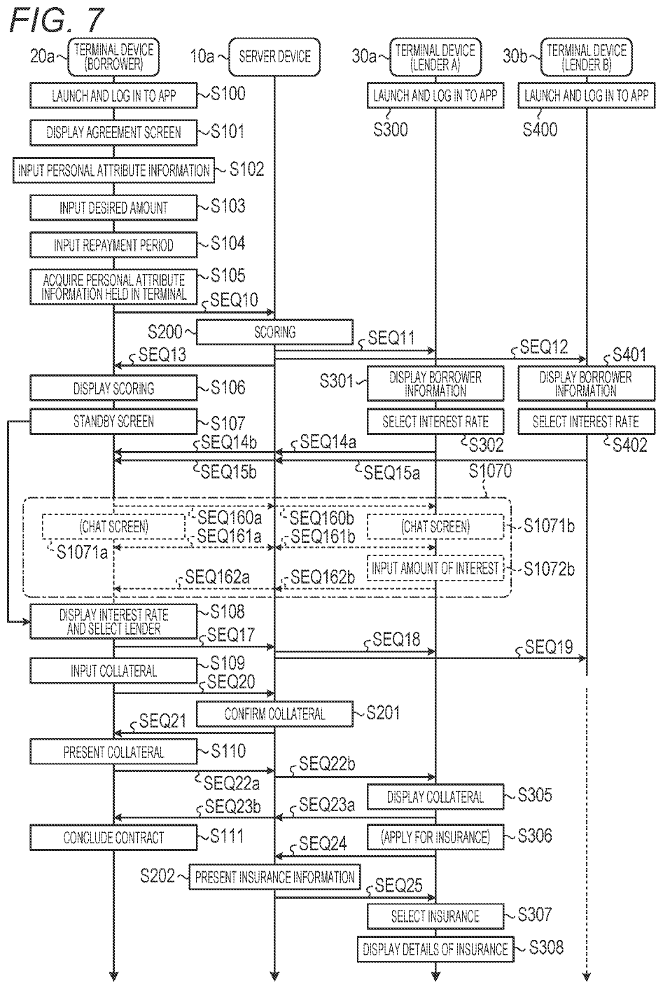

FIG. 7 is a sequence diagram of an example illustrating a flow of matching processing in P2P lending according to the embodiment. Note that a description with reference to FIG. 7 will be given on the assumption that the lender A who operates the terminal device 30a and the lender B who operates the terminal device 30b participates in P2P lending. Furthermore, it is assumed that the application unit 200 common to the terminal device 20a and the terminal devices 30a and 30b is used separately in terms of function between the borrower side and the lender side. Furthermore, unless otherwise specified, an application program for configuring the application unit 200 is simply referred to as an app.

In step S100, the borrower launches the app on the terminal device 20a and logs in to the app. Although not illustrated, when the login to the app is performed on the terminal device 20a, the app (application unit 200) communicates with the server device 10a, and a login to the server device 10a is performed via the terminal device 20a accordingly.

Note that the borrower can log in to the server device 10a even without explicitly registering account information in the server device 10a (information processing system 1). Alternatively, the information processing system 1 can perform a registration of account information of the borrower using, for example, identification information and a password set by the borrower and manage the information of the borrower.

On the other hand, the lender A and the lender B each register account information in the server device 10a in advance. In this case, the server device 10a stores, as the account information of the lenders A, B, identification information for identifying each lender and a password into the lender information storage unit 103 with the identification information and the password associated with each other, for example. At this time, the server device 10a can store attribute information of each lender into the lender information storage unit 103 with the attribute information associated with the identification information of the lender.

In step S300, the lender A launches the app on the terminal device 30a, and inputs, for example, the identification information of the lender A and the password of the lender A to log in to the app. Although not illustrated, when the login to the app is performed on the terminal device 30a, the app (application unit 200) communicates with the server device 10a, and a login to the server device 10a is performed via the terminal device 30a accordingly.

Similarly, in step S400, the lender B launches the app on the terminal device 30b, and inputs, for example, the identification information of the lender B and the password of the lender B to log in to the app, to thereby log in to the server device 10a.

In the terminal device 20a of the borrower side, in step S101, the application unit 200 causes the display device 2020 to display an agreement screen requesting agreement to input and collection of personal attribute information and acquisition of information held in the terminal device 20a (for example, the SNS/mobile application data 333 and the Web cookie 334). Hereinafter, displaying a screen on the display device 2020 of the terminal device 20a will be simply described as displaying a screen on the terminal device 20a.

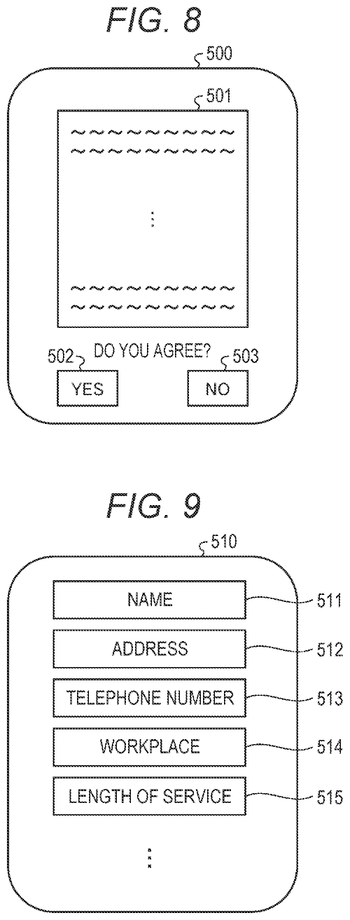

FIG. 8 is a diagram schematically illustrating an example of an agreement screen 500 displayed on the terminal device 20a by the application unit 200. On the agreement screen 500, a display area 501 and buttons 502 and 503 are placed. In the display area 501, a message prompting agreement to acquisition of information held in the terminal device 20a is displayed. The button 502 is a button indicating agreement to the message displayed in the display area 501. Furthermore, the button 503 is a button indicating disagreement to the message.

In a case where the button 503 is operated, the borrower cannot use P2P lending according to the embodiment. For example, in the terminal device 20a, in a case where the button 503 is operated, the application unit 200 does not execute step S102 and the subsequent steps.

In a case where the button 502 is operated in step S101, in the terminal device 20a, the application unit 200 displays a customer attribute input screen for inputting the personal attribute information 331 of the borrower in step S102. FIG. 9 is a diagram schematically illustrating an example of a customer attribute input screen 510. In the example illustrated in FIG. 9, input areas 511, 512, 513, 514, 515, . . . for inputting the personal attribute information of the borrower are placed on the customer attribute input screen 510.

For example, the input area 511 is an area for inputting a name of the borrower. The input area 512 is an area for inputting an address of the borrower. The input area 513 is an area for inputting a contact address (a telephone number in this example) of the borrower. The input area 514 is an area for inputting a workplace of the borrower. Furthermore, the input area 515 is an area for inputting a length of service of the borrower at the workplace input to the input area 514 by the borrower. On the customer attribute input screen 510, another input area for inputting another personal attribute information can be further placed.

Note that the borrower can skip input of personal attribute information to an input area other than input areas corresponding to required input items (for example, the name, the address, the contact address, the workplace, and the length of service) among the input areas placed on the customer attribute input screen 510.

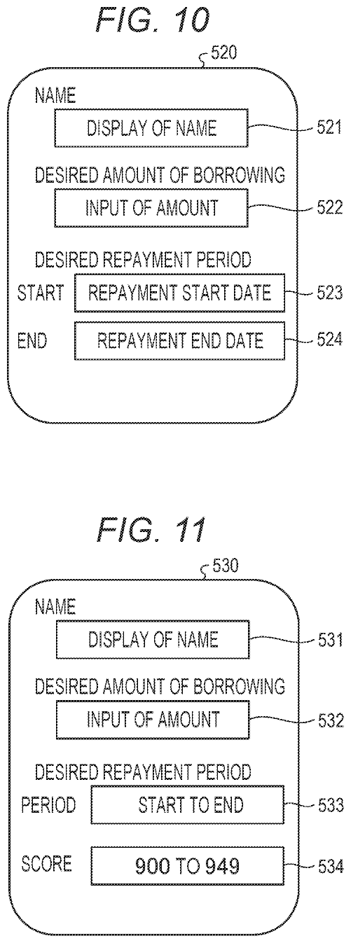

When the input of the personal attribute information to the customer attribute input screen 510 is completed and, for example, a button (not illustrated) placed on the customer attribute input screen 510 is operated, the application unit 200 of the terminal device 20a displays an amount and repayment period input screen for inputting a desired amount and a desired repayment period in steps S103 and S104. FIG. 10 is a diagram schematically illustrating an example of an amount and repayment period input screen 520. In the example illustrated in FIG. 10, a display area 521 and input areas 522, 523, and 524 are placed on the amount and repayment period input screen 520.

The display area 521 is an area in which the name of the borrower is displayed. The application unit 200 of the terminal device 20a displays, in the display area 521, the name input to the input area 511 of the customer attribute input screen 510 described above.

The input area 522 is an area for inputting an amount the borrower desires to borrow, and the input areas 523 and 524 are areas for inputting a repayment period in which the borrower repays an amount borrowed. In the example illustrated in FIG. 10, a repayment start date and a repayment end date are input to the input area 523 and the input area 524, respectively.

When the input to the amount and repayment period input screen 520 is completed and, for example, a button (not illustrated) placed on the amount and repayment period input screen 520 is operated, the application unit 200 of the terminal device 20a causes the information acquisition unit 214 to acquire the personal information of the borrower (for example, the SNS/mobile application data 333 and the Web cookie 334) from the inside of the terminal device 20a in step S105.

The application unit 200 of the terminal device 20a transmits, to the server device 10a, the attribute information 330 regarding the borrower including the personal information acquired from the inside of the terminal device 20a, the personal attribute information input to the customer attribute input screen 510 in step S102, and information indicating the desired amount of borrowing and the desired repayment period input to the amount and repayment period input screen 520 in steps S103 and S104 (SEQ10).

In step S200, the server device 10a performs scoring using the customer scoring model 320 on the basis of the attribute information 330 transmitted from the terminal device 20a to calculate a rating. Furthermore, the server device 10a generates interest rate information using the rating thus calculated. Alternatively, the server device 10a may calculate the rating and generate the interest rate information by means of scoring. The calculated rating and generated interest rate information are transmitted to the terminal device 30a of the lender A and the terminal device 30b of the lender B together with the attribute information 330 regarding the borrower (SEQ11, SEQ12). At this time, the attribute information 330 regarding the borrower transmitted from the server device 10a to the terminal devices 30a and 30b includes at least information indicating the name of the borrower, the desired amount of borrowing, and the desired repayment period.

Furthermore, the server device 10a transmits, of the calculated rating and the interest rate information, the rating to the terminal device 20a of the borrower (SEQ13). In the terminal device 20a of the borrower, the application unit 200 displays the rating transmitted from the server device 10a by means of scoring display in step S106. FIG. 11 is a diagram schematically illustrating an example of a scoring screen 530 on which the application unit 200 of the terminal device 20a of the borrower displays the rating.

In FIG. 11, display areas 531, 532, 533, and 534 are placed on the scoring screen 530. The display area 531 is an area in which the name of the borrower input on the customer attribute input screen 510 is displayed. The display areas 532 and 533 are areas in which the desired amount of borrowing and the desired repayment period input on the amount and repayment period input screen 520 are displayed. The display area 534 is an area in which the rating (score) regarding the borrower transmitted from the server device 10a is displayed. In the example illustrated in FIG. 11, a range of 900 [point] to 949 [point] is displayed in the display area 534, indicating that the rating falls within the range.

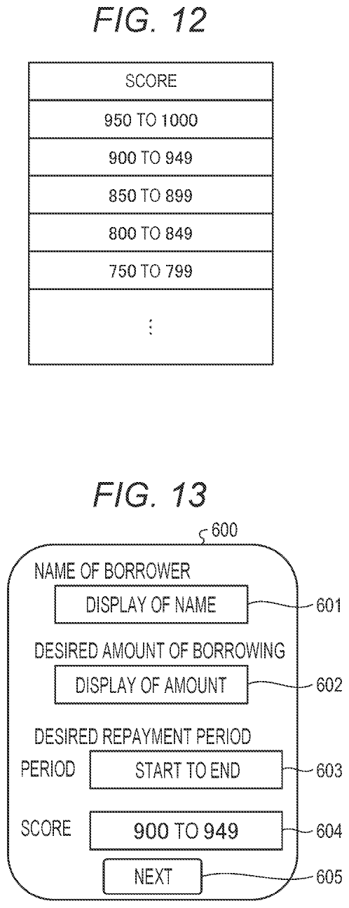

Here, the application unit 200 of the terminal device 20a rounds the rating transmitted from the server device 10a in a predetermined range and displays the rating thus rounded in the display area 534. FIG. 12 is a diagram schematically illustrating an example of how the rating (score) is rounded. Here, it is assumed that the rating is a value counted in units of one point in a range of 0 [point] to 1000 [point]. The greater the numerical value of the rating, the higher the evaluation. For example, it can be determined that the greater the numerical value of the rating, the higher creditworthiness of the borrower and the lower the default risk of the borrower.

In the example illustrated in FIG. 12, the application unit 200 of the terminal device 20a rounds the rating in a range of 50 [points] and displays the rating thus rounded. Displaying the rounded rating as described above makes it possible to create a margin in the determination of the rating and lower a psychological barrier between the borrower and the lender. Furthermore, displaying the rounded rating makes it possible to weaken the nature of simulation in which the borrower adjusts the input value on the customer attribute input screen 510 or the amount and repayment period input screen 520.

After the scoring display in step S106, the application unit 200 of the terminal device 20a causes a transition to a standby screen in response to a predetermined operation (for example, an operation of a button (not illustrated)) on the scoring screen 530 (step S107). A specific example of the standby screen will be described later.

In the terminal device 30a of the lender A, the application unit 200 displays, in step S301, a borrower confirmation screen for presenting the attribute information 330 regarding the borrower transmitted from the server device 10a in SEQ11. FIG. 13 is a diagram schematically illustrating an example of a borrower confirmation screen 600. In the example illustrated in FIG. 13, the borrower confirmation screen 600 is similar in configuration to the scoring screen 530 illustrated in FIG. 11, and display areas 601, 602, 603, and 604 are placed on the borrower confirmation screen 600. Moreover, a button 605 is placed on the borrower confirmation screen 600.

The display area 601 is an area in which the name of the borrower included in the attribute information 330 regarding the borrower transmitted from the server device 10a is displayed. The display areas 602 and 603 are areas in which the desired amount of borrowing and the desired repayment period included in the attribute information 330 are displayed. The display area 604 is an area in which the rating (score) regarding the borrower transmitted from the server device 10a is displayed. The borrower confirmation screen 600 allows the lender A to confirm the name of the borrower and borrowing conditions (amount, repayment period). Moreover, the borrower confirmation screen 600 allows the lender A to confirm the rating (score) of the borrower.

The button 605 is a button for causing the application unit 200 of the terminal device 30a to display the next screen (proceed to the next processing). In response to an operation of the button 605, the application unit 200 of the terminal device 30a causes the processing to proceed to step S302.

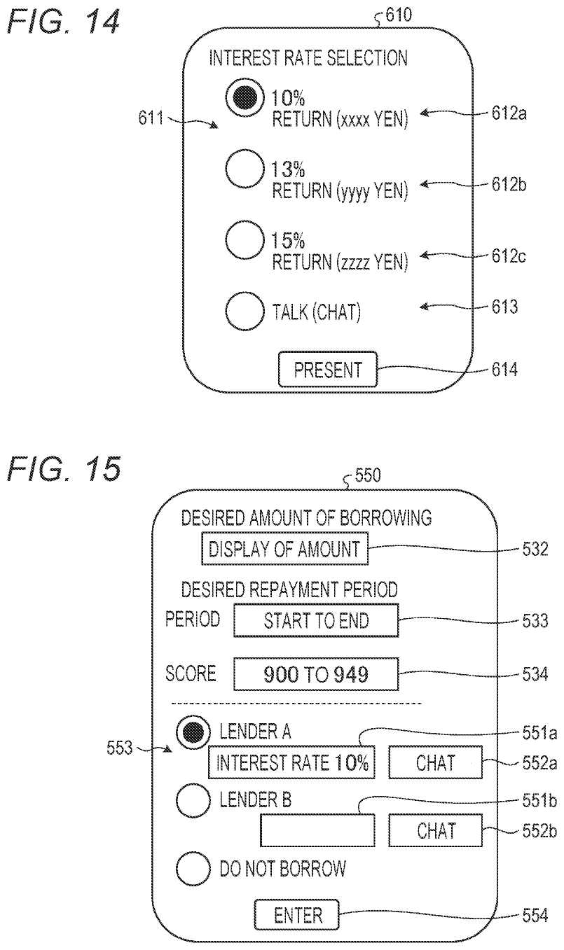

In step S302, the application unit 200 of the terminal device 30a displays an interest rate selection screen for selecting an interest rate to be presented to the borrower. FIG. 14 is a diagram schematically illustrating an example of an interest rate selection screen 610. In FIG. 14, a plurality of interest rate displays 612a, 612b, and 612c, talk 613, and a radio button group 611 including a plurality of radio buttons for selecting one from among the interest rate displays 612a, 612b, and 612c, and the talk 613 are placed on the interest rate selection screen 610.

For example, the server device 10a generates one or more pieces of interest rate information using the rating of the borrower. Alternatively, the application unit 200 of the terminal device 30a can generate the one or more pieces of interest rate information using the rating. The one or more pieces of interest rate information thus generated are displayed on the interest rate selection screen 610 as the interest rate display together with an amount of return based on the amount of borrowing desired by the borrower. In the example illustrated in FIG. 14, three types of interest rates of 10%, 13%, and 15%, and the interest rate displays 612a, 612b, and 612c each indicating a corresponding amount of return are displayed on the interest rate selection screen 610.

Here, the rating indicates the creditworthiness of the borrower for repayment, and the interest rate for the borrower can be set using the rating as an index. For example, the server device 10a may set a low interest rate for a borrower having a high rating, that is, high creditworthiness for repayment, and set a high interest rate for a borrower having a low rating, that is, low creditworthiness for repayment.

The talk 613 is provided for selecting an interest rate determined by means of a direct negotiation with the borrower. The direct negotiation for an interest rate with the borrower will be described later.

When the lender A operates a radio button corresponding to any one of the interest rate displays 612a, 612b, and 612c among the radio buttons included in the radio button group 611, interest rate information indicating an interest rate on the interest rate display corresponding to the operation is transmitted from the terminal device 30a of the lender A to the terminal device 20a of the borrower via the server device 10a (SEQ14a, SEQ14b). Here, in the terminal device 20a of the borrower, upon receipt of the interest rate information from the terminal device 30a, the application unit 200 can display the interest rate based on the interest rate information thus received or the amount of interest based on the interest rate on the standby screen (to be described later) displayed in step S107.

Note that the terminal device 30b of the lender B is similar in processing and display to the terminal device 30a of the lender A. That is, in the terminal device 30b of the lender B, the application unit 200 displays, in step S401, the borrower confirmation screen 600 for presenting the attribute information 330 regarding the borrower transmitted from the server device 10a in SEQ12. When the button 605 is operated on the borrower confirmation screen 600, the application unit 200 of the terminal device 30b of the lender B causes the processing to proceed to step S402 to display the interest rate selection screen 610.

When the lender B operates a radio button corresponding to any one of the interest rate displays 612a, 612b, and 612c among the radio buttons included in the radio button group 611, interest rate information indicating an interest rate on the interest rate display corresponding to the operation is transmitted from the terminal device 30b of the lender B to the terminal device 20a of the borrower via the server device 10a (SEQ15a, SEQ15b). In this case as well, in the terminal device 20a of the borrower, upon receipt of the interest rate information from the terminal device 30b, the application unit 200 can display the interest rate or the amount of interest based on the interest rate information thus received on the standby screen (to be described later) displayed in step S107.

FIG. 15 is a diagram schematically illustrating an example of a standby screen 550 displayed by the application unit 200 on the terminal device 20a of the borrower side. In the example illustrated in FIG. 15, the standby screen 550 is based on the scoring screen 530 illustrated in FIG. 11 and further includes display areas 551a and 551b in which the interest rates presented by the lenders A, B are displayed, buttons 552a and 552b for requesting a chat with the lenders A, B, a button 554 for indicating a determination of a lender, and a radio button group 553 including a plurality of radio buttons for selecting a lender. The display areas 532 to 534 illustrated in FIG. 15 are the same as the display areas 532 to 534 of the scoring screen 530 illustrated in FIG. 11, so that no description will be given here of the display areas 532 to 534.

In the display area 551a, the interest rate information (the interest rate or the amount of interest according to the desired amount of borrowing) transmitted from the terminal device 30a of the lender A to the terminal device 20a of the borrower in SEQ14a and SEQ14b is displayed, for example. Similarly, in the display area 551b, the interest rate information transmitted from the terminal device 30b of the lender B to the terminal device 20a of the borrower in SEQ15a and SEQ15b is displayed, for example.

Here, the display of the interest rate information in the display areas 551a and 551b can be updated in response to the transmission of the interest rate information from the terminal devices 30a and 30b. In the example illustrated in FIG. 15, at this point of time, the interest rate information from the terminal device 30a of the lender A has been received by the terminal device 20a, and the interest rate information from the terminal device 30b of the lender B has yet to be received by the terminal device 20a. Therefore, in the example illustrated in FIG. 15, the interest rate based on the interest rate information received from the terminal device 30a is displayed in the display area 551a, but the display area 551b is blank. When the terminal device 20a receives the interest rate information from the terminal device 30b, the display of the display area 551b is updated, and the interest rate information thus received is displayed in the display area 551b.

In the example illustrated in FIG. 15, the buttons 552a and 552b are buttons for requesting a chat for communicating with the lenders A and B, respectively. Operating the button 552a or 552b enables a chat between the terminal device 20a and the terminal device 30a or 30b (step S1070). A description will be given below of an example in which a chat is performed between the terminal device 20a and the terminal device 30a.

Note that a chat refers to real-time communications using a data communication line over a computer network including the Internet. During a chat, on a communication screen (chat screen) for performing communications, messages sent by each participant in the chat are displayed in chronological order so as to make speakers distinguishable. Note that, as a method of performing communications between the lender A and the borrower by electronic means, there are various possible options such as exchanges by e-mail, a video conference using a moving image obtained by imaging the lender A and the borrower, and the like other than a chat. Here, a description will be given of a chat as an example.

For example, in the terminal device 20a, the application unit 200 requests the server device 10a to enable a chat with the lender A in response to the operation of the button 552a (SEQ160a). The terminal device 20a displays a chat screen (communication screen) for performing a chat (step S1071a). Furthermore, in response to the request in SEQ160a, the server device 10a notifies the terminal device 30a of the lender A of the start of the chat (SEQ160b). The terminal device 30a of the lender A displays the chat screen in response to the notification in SEQ160b (step S1071b). The server device 10a transmits a text input to terminal device 20a to terminal device 30a (SEQ161b), and transmits a text input to the terminal device 30a to the terminal device 20a (SEQ161a), to thereby perform the chat between the terminal device 20a and the terminal device 30a.

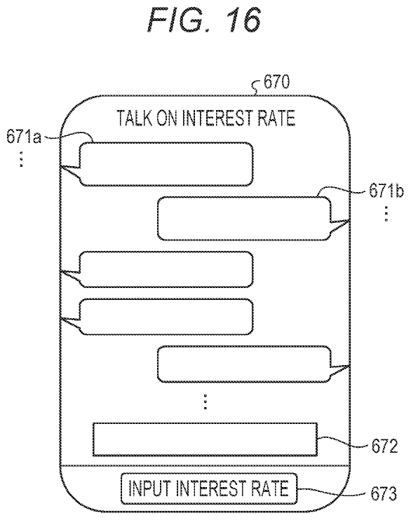

FIG. 16 is a diagram schematically illustrating an example of a chat screen 670 showing a chat performed between the borrower and the lender A. Note that, for the sake of description, an example of the chat screen 670 of the lender A side is illustrated here. Note that the chat screen 670 has a configuration common to the screen displayed on the terminal device 20a of the borrower and the screen displayed on the terminal device 30a of the lender A except for a button 673 placed at the bottom.

In FIG. 16, on the chat screen 670, a message 671b of the lender A side is displayed together with a message 671a of the borrower side input using a similar screen and transmitted from the terminal device 20a of the borrower in chronological order of message transmission from the upper portion toward the lower portion of the chat screen 670.

On the chat screen 670, the button 673 is a button for causing a transition from the chat screen 670 to a screen for inputting an interest rate determined by the lender A according to contents of the chat. In the terminal device 30a of the lender A, the application unit 200 displays an interest rate information input screen in response to the operation of the button 673 (step S1072b).

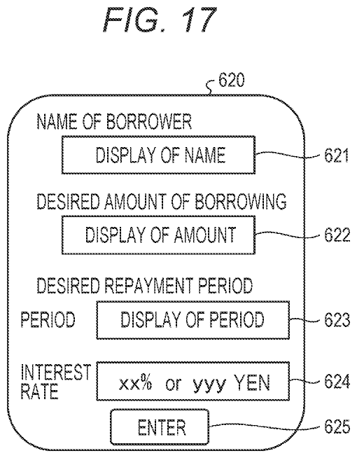

FIG. 17 is a diagram schematically illustrating an example of an interest rate information input screen 620 displayed on the terminal device 30a of the lender A. In FIG. 17, display areas 621, 622, and 623, an input area 624, and a button 625 are placed on the interest rate information input screen 620.

On the interest rate information input screen 620, the display areas 621, 622, and 623 correspond to the display areas 601, 602, and 603 on the borrower confirmation screen 600 described with reference to FIG. 13, and the name of the borrower, the desired amount of borrowing, and the desired repayment period are displayed in the display areas 621, 622, and 623, respectively. In the terminal device 30a, the application unit 200 can display the respective pieces of information displayed in the display areas 601, 602, and 603 on the borrower confirmation screen 600 illustrated in FIG. 13 as they are in the display areas 621, 622, and 623.

On the interest rate information input screen 620, the input area 624 is an area to which interest rate information indicating an interest rate determined by the lender A (an interest rate or an amount of interest according to the interest rate) is input. Furthermore, the button 625 is a button for transmitting a value input to the input area 624. In the terminal device 30a, when the button 625 is operated with the interest rate information input to the input area 624, the application unit 200 transmits the value (interest rate) input to the input area 624 to the terminal device 20a of the borrower via the server device 10a (SEQ162a, SEQ162b). The operation of the button 625 terminates the chat in step S1070.

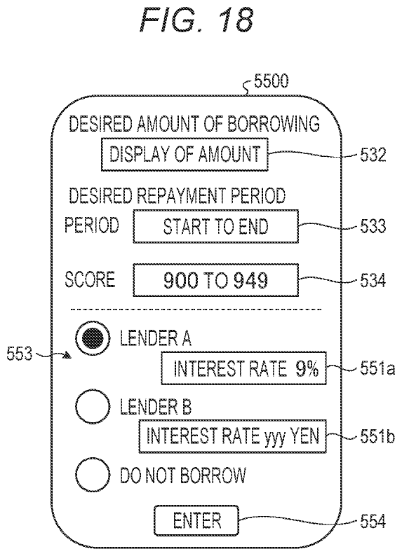

In the terminal device 20a of the borrower, upon receipt of the interest rate information transmitted from the terminal device 30a of the lender A via the server device 10a, the application unit 200 causes the terminal device 20a to display a lender selection screen (step S108). FIG. 18 is a diagram schematically illustrating an example of a lender selection screen 5500 displayed by the application unit 200 on the terminal device 20a.

In the example illustrated in FIG. 18, the lender selection screen 5500 has a configuration in which the buttons 552a and 552b for requesting a chat are removed from the standby screen 550 illustrated in FIG. 15. Furthermore, the interest rate information presented from the lender A and the interest rate information presented from the lender B are displayed in the display areas 551a and 551b, respectively.

Here, on the lender selection screen 5500, the interest rate information (“interest rate 9%” in this example) displayed in the display area 551a is interest rate information updated, in accordance with the interest rate information input to the input area 624 on the interest rate information input screen 620 illustrated in FIG. 17, from the interest rate information (“interest rate 10%” in the example illustrated in FIG. 15) displayed in the display area 551a on the standby screen 550 illustrated in FIG. 15. On the other hand, the interest rate information displayed in the display area 551b indicates a value selected on the interest rate selection screen 610 illustrated in FIG. 14 in the terminal device 30a of the lender B in step S402 described above.

The borrower uses a plurality of radio buttons included in the radio button group 553 to select between the lender A and the lender B or determine not to borrow money. In other words, it can be said that the interest rate information displayed together with a radio button group 53 serves as a message for prompting the borrower to designate whether or not to accept, for example, either the interest rate information presented by the lender A or the interest rate information presented the lender B.

In the terminal device 20a of the borrower, the application unit 200 notifies the server device 10a of the selection result using the radio button group 553 in response to the operation of the button 554 of the lender selection screen 5500 (SEQ17). The server device 10a transmits the selection result transmitted from the terminal device 20a of the borrower to both the terminal devices 30a and 30b of the lenders A and B (SEQ18, SEQ19).

Here, in the terminal device 20a of the borrower, in a case where “Do not borrow (cancel borrowing)” is selected on the lender selection screen 5500, the application unit 200 prevents the terminal device 20a from performing the subsequent processing. Similarly, in each of the terminal devices 30a and 30b of the lenders A and B, in a case where “Do not borrow” is transmitted from the server device 10a as the selection result of the terminal device 20a of the borrower, a corresponding application unit 200 does not perform the subsequent processing.

In the following description, it is assumed that the lender A is selected on the lender selection screen 5500.

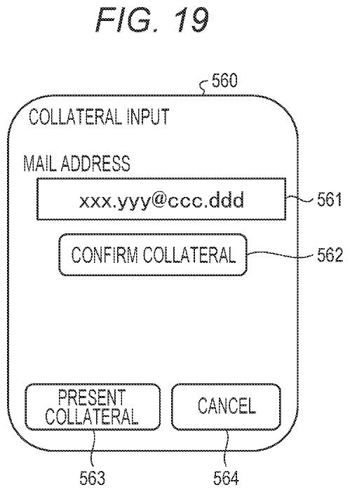

In the terminal device 20a of the borrower, when a lender to which a request for a loan is made is determined, the application unit 200 sets collateral in the next step S109. FIG. 19 is a diagram schematically illustrating an example of a collateral input screen 560 displayed by the application unit 200 on the terminal device 20a of the borrower.

In FIG. 19, an input area 561 and buttons 562, 563, and 564 are placed on the collateral input screen 560. The input area 561 is an area for inputting collateral information indicating collateral. The button 562 is a button for confirming the collateral information input to the input area 561. The button 563 is a button for presenting the collateral information input to the input area 561 to the lender selected on the lender selection screen 5500. Furthermore, the button 564 is a button for terminating the series of processing in P2P lending.

The borrower presents to the lender collateral information whose right is transferred to the lender in case of default on a received loan. In the embodiment, electronic collateral information is applied as collateral information indicating collateral. As the electronic collateral information that is applicable as collateral, an e-mail address regularly used by the borrower, account information for an SNS, account information for a rental server, or the like can be applied. In the example illustrated in FIG. 19, an e-mail address regularly used by the borrower is input as the electronic collateral information to the input area 561.

For example, in a case where an e-mail address is set as the electronic collateral information, and the borrower defaults on a loan, the e-mail address thus set is disabled. As another example, in a case where account information for an SNS is set as the electronic collateral information, and the borrower defaults on a loan, the account indicated by the account information is deactivated.

Here, for example, on the server device 10a side, an arrangement may be made in advance so as to be able to request a system (for example, an e-mail or SNS operation system) that can be set as the electronic collateral information to disable the use of the user's e-mail address or deactivate the user's account.

In the terminal device 20a, the application unit 200 transmits the collateral information input to the input area 561 to the server device 10a in response to the operation of the button 562 (SEQ20). Note that, at this point of time, it is preferable that the button 563 be in an inactive state or the button 563 be in a hidden state.

The server device 10a confirms the collateral on the basis of the collateral information transmitted from the terminal device 20a in SEQ20, and determines whether or not the collateral is reliable (step S201). For example, in a case where the collateral information is an e-mail address, the server device 10a confirms whether or not communications using the e-mail address are possible, and confirms whether or not the e-mail address really exists and belongs to the borrower. In a case where the e-mail address neither really exists nor belongs to the borrower, the server device 10a can take a measure such as requesting the terminal device 20a of the borrower to present valid collateral or terminating the subsequent processing on the borrower.

Note that, in the terminal device 20a, the application unit 200 can change the type of collateral or the number of pieces of collateral to be requested according to the rating of the borrower. For example, in a case where the rating of the borrower is less than or equal to a predetermined value, the application unit 200 can display a plurality of input areas 561 on the collateral input screen 560 to request the borrower to present a plurality of pieces of collateral. In this case, in a case where the server device 10a has confirmed that all the pieces of collateral belong to the borrower, the server device 10a allows the terminal device 20a to continue the subsequent processing.

In a case where the server device 10a has successfully confirmed that the collateral indicated by the collateral information transmitted from the terminal device 20a of the borrower in step S201 belongs to the borrower, the server device 10a transmits a notification indicating that the collateral has been confirmed to the terminal device 20a (SEQ21). In the terminal device 20a, upon receipt of the notification from the server device 10a, the application unit 200 can display, on the collateral input screen 560, a message (not illustrated) indicating that the server device 10a has confirmed the collateral (step S110). In a case where the button 563 is in the inactive state, the application unit 200 changes the button 563 to an active state. When the button 563 is changed to the active state, the collateral indicated by the collateral information is made applicable as the collateral from the borrower.

In the terminal device 20a of the borrower, in response to the operation of the button 563, the application unit 200 transmits, to the server device 10a, an instruction for transmitting the collateral input to the input area 561 to the lender A together with the collateral information (SEQ22a). In accordance with the instruction transmitted from the terminal device 20a, the server device 10a transmits the collateral information to the terminal device 30a of the lender A (SEQ22b).

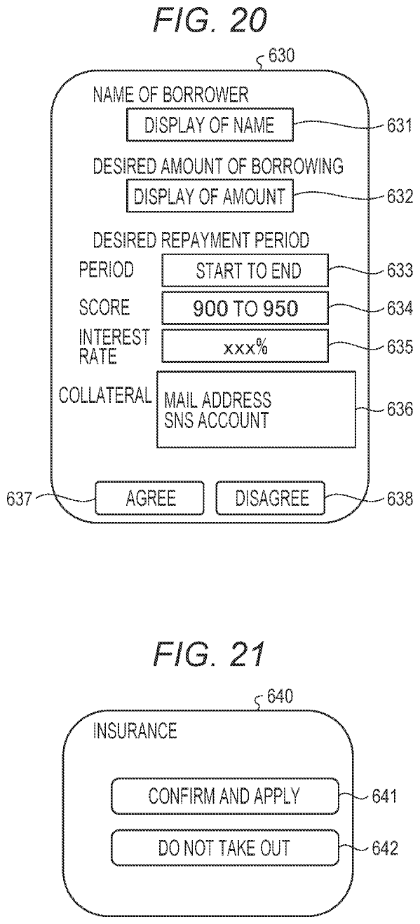

In the terminal device 30a of the lender A, the application unit 200 displays a collateral display screen for the lender A to confirm the collateral transmitted from the terminal device 20a of the borrower via the server device 10a (step S305). FIG. 20 is a diagram schematically illustrating an example of a collateral confirmation screen 630 for confirming collateral presented to the borrower. In FIG. 20, display areas 631, 632, 633, 634, 635, and 636, and buttons 637 and 638 are placed on the collateral confirmation screen 630.

In FIG. 20, the display areas 631 to 634 corresponds to the display areas 601 to 604 of the borrower confirmation screen 600 illustrated in FIG. 13, respectively, and the name of the borrower, the desired amount of borrowing, the desired repayment period, and the rating (score) are displayed in the display areas 631 to 634. In the display area 635, the interest rate information (interest rate in this example) input and set by the lender A in step S302 or step S1071b is displayed.

In the display area 636, the collateral information transmitted from the terminal device 20a of the borrower via the server device 10a is displayed. In the example illustrated in FIG. 20, the e-mail address and SNS account information of the borrower are displayed as the collateral information. Such pieces of collateral information displayed in the display area 636 have been confirmed as belonging to the borrower by the server device 10a in step S201.

The button 637 is a button for notifying the server device 10a of agreement to the loan to the borrower. Furthermore, the button 638 is a button for notifying the server device 10a of non-agreement (disagreement) to the loan to the borrower. For example, the lender A checks the display contents of the display areas 631 to 636, and operates the button 637 in a case where the lender A agrees to make the loan to the borrower. In a case where the button 637 is operated, it is considered that the P2P lending contract between the lender A and the borrower has been concluded.

On the other hand, in a case where the lender A disagrees to the loan to the borrower, the lender A operates the button 638. In this case, the P2P lending contract between the lender A and the borrower has not been concluded. That is, the buttons 637 and 638 serve as messages prompting the lender to designate whether or not to agree to accept the collateral presented by the borrower.

In the terminal device 30a, in response to the operation of the button 637 or 638, the application unit 200 transmits, to the terminal device 20a of the borrower via the server device 10a, contract result information indicating agreement or disagreement to the P2P lending contract with the borrower (SEQ23a, SEQ23b). In the terminal device 20a of the borrower, the application unit 200 displays contents indicated by the contract result information (not illustrated). In this case, the contents indicated by the contract result information correspond to, for example, information indicating whether or not the P2P lending contract between the lender A and the borrower has been concluded.

In the terminal device 30a of the lender A, in a case where the button 637 is operated in step S305 to indicate agreement to the P2P lending contract with the borrower, the application unit 200 displays an insurance application determination screen for applying for insurance in step S306. That is, in a case where the P2P lending contract with the borrower has been concluded, the lender A can apply insurance to the contract in order to avoid a risk such as default.

FIG. 21 is a diagram schematically illustrating an example of an insurance application determination screen 640 for determining whether or not to apply insurance. In FIG. 21, buttons 641 and 642 are provided on the insurance application determination screen 640. The button 642 is a button indicating that no insurance is applied to the loan. In a case where the button 642 is operated, the application unit 200 of the terminal device 30a is prevented from performing the subsequent processing. In this case, the P2P lending contract between the lender A and the borrower is concluded without taking out insurance introduced by the information processing system 1.

The button 641 is a button to be operated when insurance is applied to the loan. In the terminal device 30a, the application unit 200 transmits an insurance application request for applying for insurance to the server device 10a (SEQ24).

The server device 10a presents insurance information to the terminal device 30a in response to the insurance application request transmitted from the terminal device 30a (step S202). For example, the server device 10a presents, to the lender A, insurance information of one or more types of insurance evaluated to be suitable for the P2P lending contract concluded between the lender A and the borrower on the basis of various types of insurance information acquired in advance from the insurance companies 40a, 41b, . . . . Here, the server device 10a can set insurance to be presented to the lender A according to the rating of the borrower who has concluded the P2P lending contract with the lender A. For example, in a case where the rating is less than or equal to the predetermined value, the server device 10a can present a plurality of types of insurance to the lender A.

The server device 10a transmits information of one or more types of insurance to be presented to the lender A to the terminal device 30a of the lender A (SEQ25). In the terminal device 30a of the lender A, the application unit 200 displays an insurance selection screen for presenting one or more types of insurance to the lender A and prompting the lender A to select insurance (step S307).

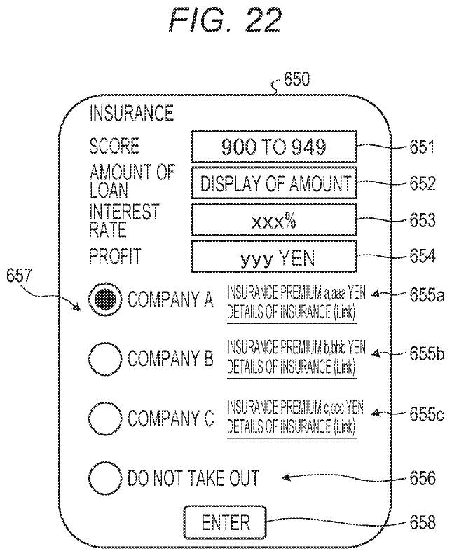

FIG. 22 is a diagram schematically illustrating an example of an insurance selection screen 650 for selecting applicable insurance displayed by the application unit 200 of the terminal device 30a. In FIG. 22, display areas 651, 652, 653, and 654, insurance information presentation areas 655a, 655b, 655c, and 656, a radio button group 657 including a plurality of radio buttons, and a button 658 are placed on the insurance selection screen 650.

The display area 651 is an area in which the rating (score) of the borrower to which the lender A has determined to make a loan is displayed. The display area 652 is an area in which an amount of the loan to the borrower is displayed. The desired amount of borrowing included in the attribute information 330 regarding the borrower transmitted from the server device 10a in SEQ11 described above is applied to the amount of the loan.

The display area 653 is an area in which interest rate information indicating an interest rate associated with the loan is displayed. The interest rate is displayed in the display area 653 on the basis of the interest rate information displayed in the display area 635 on the collateral confirmation screen 630 illustrated in FIG. 20 described above. The display area 654 is an area in which a profit that the lender A gains is displayed. The profit can be calculated by the application unit 200 in the terminal device 30a on the basis of the amount of the loan and the interest rate, for example.

In each of the insurance information presentation areas 655a, 655b, and 655c, insurance information acquired from a corresponding one of the insurance companies 40a, 40b, . . . , which are, for example, non-life insurance companies, is displayed by the server device 10a. In this example, pieces of insurance information of three insurance companies A, B, and C are displayed in the insurance information presentation areas 655a, 655b, and 655c, respectively. In this example, each piece of insurance information includes an insurance premium and link information (for example, a uniform resource locator (URL) of a website) indicating details of corresponding insurance. On the other hand, the insurance information presentation area 656 is provided for specifying that no insurance is applied.

The lender A designates desired insurance information from the desired insurance information presentation areas 655a, 655b, 655c, and 656 using the plurality of radio buttons included in the radio button group 657 on the insurance selection screen 650 displayed on the terminal device 30a. In the terminal device 30a, in a case where the button 658 is operated after any one of the insurance information presentation areas 655a, 655b, and 655c is designated, the application unit 200 displays an insurance detail display screen showing details of the insurance information presented in the designated insurance information presentation area (step S308).

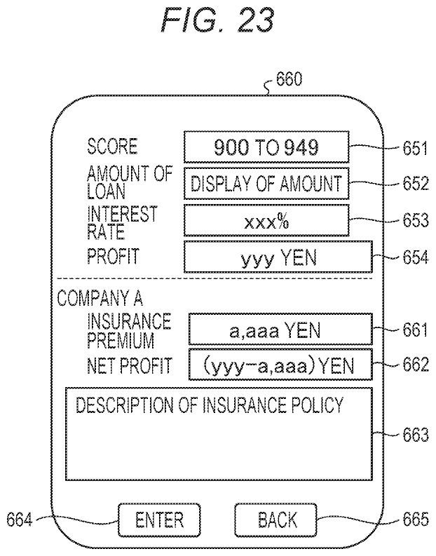

FIG. 23 is a diagram schematically illustrating an example of an insurance detail display screen 660 displayed by the application unit 200 of the terminal device 30a. Here, a description will be given on the assumption that the insurance company A has been selected on the insurance selection screen 650 illustrated in FIG. 22. In FIG. 23, display areas 651, 652, 653, 654, 661, 662, and 663 and buttons 664 and 665 are placed on the insurance detail display screen 660. Among these, the display areas 651 to 654 are the same as the display areas 651 to 654 of the insurance selection screen 650 illustrated in FIG. 22, so that no description will be given here of the display areas 651 to 654.

The display area 661 is an area in which an insurance premium is displayed. In this example in which the insurance company A has been selected, the insurance premium presented to the insurance information presentation area 655a is displayed in the display area 661. A net profit that the lender A gains is displayed in the display area 662, the net profit being obtained by deducting the insurance premium displayed in the display area 661. For example, in the terminal device 30a of the lender A, the application unit 200 displays, in the display area 622, a value obtained by deducting the insurance premium displayed in the display area 661 from the profit displayed in the display area 654 as the net profit.

In the display area 663, details regarding an insurance policy of the insurance are displayed. For example, the terminal device 30a acquires information of the insurance policy on the basis of the link information presented to the insurance information presentation area 655a, and displays the information in the display area 663.

The button 664 is a button for determining to take out the insurance whose details are displayed in the display areas 661 to 663 on the insurance detail display screen 660. In the terminal device 30a, in a case where the button 664 is operated, the application unit 200 requests the insurance company A (insurance company 40a) to conclude an insurance contract with the insurance company A with the contents displayed in the display areas 661 to 663. In response to this request, the insurance company A can present, to the terminal device 30a, information (for example, registration information such as a credit card) for paying the insurance premium.

Alternatively, the terminal device 30a may transmit a request for conclusion of the insurance contract with the insurance company A or the like to the insurance company 40a via the server device 10a.

On the other hand, in a case where the button 665 is operated on the insurance detail display screen 660, the application unit 200 of the terminal device 30a can return the display to the insurance selection screen 650 described with reference to FIG. 22, for example. In this case, the lender A can take an action such as selecting another insurance company from among the presented insurance companies or not making an insurance contract.

Then, the matching processing in P2P lending according to the embodiment of the present disclosure is brought to an end.

As described above, the information processing system according to the embodiment of the present disclosure performs machine learning using the attribute information 300 regarding a plurality of borrowers to create the customer scoring model, and calculates a rating of the borrower using the customer scoring model on the basis of the attribute information 330 regarding the borrower. On the lender side, an interest rate for the borrower and collateral can be set on the basis of the rating. It is therefore possible to reduce a risk in P2P lending.

Furthermore, the information processing system according to the embodiment of the present disclosure presents one or more types of insurance to the lender according to the rating of the borrower. It is therefore possible to further reduce the risk in P2P lending.

### 2. Modification of Embodiment

Next, a modification of the embodiment will be described. In the above-described embodiment, a description has been given of the example where, in the terminal device 20a of the borrower and the terminal devices 30a, 30b, . . . of the lenders, the matching processing in P2P lending according to the embodiment is implemented by the app preinstalled on the terminal devices 20a, 30a, 30b, . . . , but the configuration is not limited to this example. In the modification of the embodiment, a function substantially equivalent to the matching processing in P2P lending according to the above-described embodiment is implemented by a Web app that runs on the server device 10a.

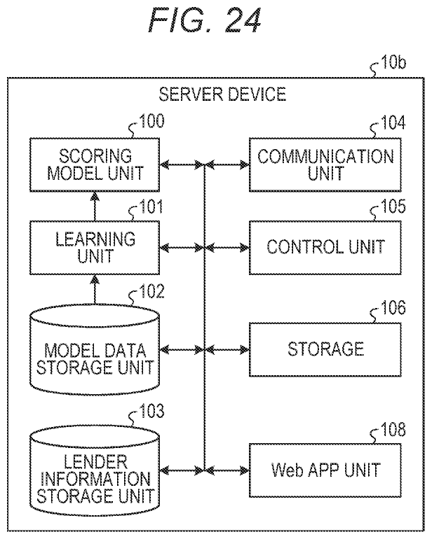

FIG. 24 is a functional block diagram of an example for describing a function of a server device according to the modification of the embodiment. In FIG. 24, a server device 10b is provided with a Web app unit 108 instead of the app storage unit 107 in the server device 10a described with reference to FIG. 2.

In the server device 10b, a scoring model unit 100, a learning unit 101, a model data storage unit 102, a lender information storage unit 103, a communication unit 104, a control unit 105, and a storage 106 are each the same in function as a corresponding unit of the server device 10a described with reference to FIG. 2, so that no description will be given here of the scoring model unit 100, the learning unit 101, the model data storage unit 102, the lender information storage unit 103, the communication unit 104, the control unit 105, and the storage 106. Furthermore, in a similar manner, the hardware configuration of the server device 10a described with reference to FIG. 4 is applicable to the server device 10b as it is, so that no description will be given here of the hardware configuration.

In FIG. 24, the Web app unit 108 is written basically in HyperText Markup Language (HTML), for example, and stores a Web app 230 that is loaded onto Web browsers of the terminal devices 20a, 30a, 30b, . . . to run on the Web browsers.

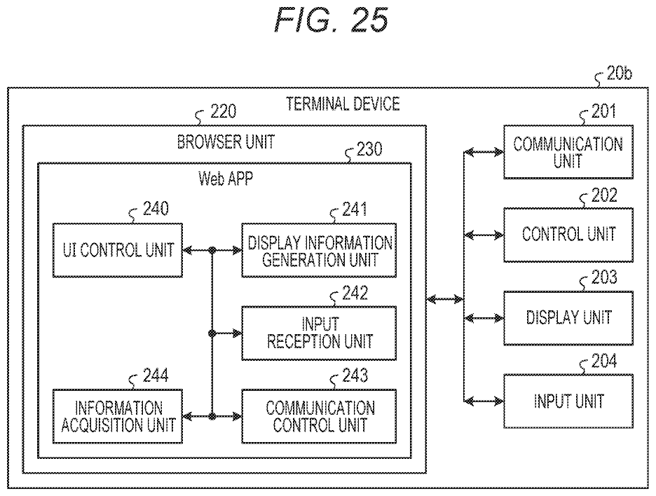

FIG. 25 is a functional block diagram of an example for describing a function of a terminal device according to the modification of the embodiment. In FIG. 25, a terminal device 20b is a terminal device of the borrower side corresponding to the terminal device 20a described above. The terminal device 20b includes a browser unit 220, a communication unit 201, a control unit 202, a display unit 203, and an input unit 204. Furthermore, the browser unit 220 includes the Web app 230, and the Web app 230 includes a UI control unit 240, a display information generation unit 241, an input reception unit 242, a communication control unit 243, and an information acquisition unit 244.

Among such units, the communication unit 201, the control unit 202, the display unit 203, and the input unit 204 are the same as the communication unit 201, the control unit 202, the display unit 203, and the input unit 204 in the terminal device 20a illustrated in FIG. 3, so that no description will be given here of the communication unit 201, the control unit 202, the display unit 203, and the input unit 204.

The browser unit 220 is a so-called Web browser, and can load an HTML file written in, for example, HTML over the network 2 and perform generation of the display control signal, input control, communication control, or the like in accordance with statements in the file.

The Web app 230 is loaded by the browser unit 220 from the Web app unit 108 of the server device 10b described above. When loading the Web app 230 from the Web app unit 108 of the server device 10b, the browser unit 220 generates the UI control unit 240, the display information generation unit 241, the input reception unit 242, the communication control unit 243, and the information acquisition unit 244 in the browser unit 220. The UI control unit 240, the display information generation unit 241, the input reception unit 242, the communication control unit 243, and the information acquisition unit 244 can implement functions equivalent to the UI control unit 210, the display information generation unit 211, the input reception unit 212, the communication control unit 213, and the information acquisition unit 214 in the terminal device 20a described with reference to FIG. 3, so that no description will be given here of the UI control unit 240, the display information generation unit 241, the input reception unit 242, the communication control unit 243, and the information acquisition unit 244.

Note that the terminal devices 30a, 30b, . . . of the lender side can also apply the Web app 230 in a similar manner to the terminal device 20b.

Here, the Web app 230 loaded from the Web app unit 108 onto the browser unit 220 in the terminal device 20a or the terminal devices 30a, 30b, . . . can provide the rating calculated by the scoring model unit 100 or the interest rate information generated using the rating in the server device 10a to at least the terminal devices 30a, 30b, . . . of the lenders participating in P2P lending to the borrower among the terminal device 20a, and the terminal devices 30a, 30b, . . . . That is, the Web app unit 108 functions as a provision unit that provides the rating to at least the terminal devices 30a, 30b, . . . of lenders participating in P2P lending to the borrower among the terminal device 20a, and the terminal devices 30a, 30b, . . . .

The matching processing in P2P lending according to the modification of the embodiment is similar to the processing described with reference to FIGS. 7 to 23 in the above-described embodiment, so that no description will be given here of the matching processing.

As described above, causing the Web app loaded from the server device 10b to perform the matching processing in P2P lending of the present disclosure in each of the terminal devices of the borrower side and the lender side makes it possible to improve functional maintainability and the like.

On the other hand, security settings on the browser unit 220 or the like may impose restrictions on information the information acquisition unit 244 acquires from the inside of the terminal device 20b. In this case, accessible information among pieces of information having acquisition restrictions placed thereon may be acquired by manual input.

Note that the effects described herein are merely examples and are not limited, and other effects may be provided.

Note that the present technology can also have the following configurations.

(1)

A server device includes a generation unit that generates one or more pieces of interest rate information using a rating of a borrower as an individual, the rating being calculated on the basis of attribute information of the borrower, and a provision unit that provides the one or more pieces of interest rate information to at least a second terminal device operated by a lender for the borrower out of a first terminal device operated by the borrower and the second terminal device, and provides interest rate information selected from among the one or more pieces of interest rate information in the second terminal device to the first terminal device.

(2)

In the server device according to the above (1), the presentation unit further provides, to the first terminal device and the second terminal device, information regarding a communication screen on which the borrower and the lender communicate with each other and provides information regarding an interest rate input unit configured to input interest rate information to the second terminal device in accordance with an instruction from the second terminal device.

(3)

In the server device according to the above (1) or (2), the presentation unit provides, to the first terminal device, a message prompting a designation of whether or not to accept the interest rate information presented from the second terminal device.

(4)

In the server device according any one of the above (1) to (3), the provision unit presents, to the second terminal device, at least information that is included in the attribute information and makes the borrower identifiable and the rating that is associated with the attribute information on one screen.

(5)

In the server device according to any one of the above (1) to (4), the provision unit requests the first terminal device to present a number of pieces of collateral according to the rating of the borrower.

(6)

In the server device according to the above (5), the provision unit provides, to the second terminal device, a message prompting a designation of whether or not to agree to accept the collateral presented from the first terminal device in response to the request to present the collateral.

(7)

In the server device according to the above (5) or (6), the provision unit requests the first terminal device to present, as the collateral, electronic collateral information that is made unusable by the borrower in a case where the borrower defaults on a loan.

(8)

In the server device according to the above (7), in a case where the collateral of the borrower presented from the first terminal device has been successfully confirmed, the provision unit makes the electronic collateral information applicable as the collateral.

(9)

In the server device according to any one of the above (1) to (8), the provision unit provides, to the second terminal device, one or more pieces of insurance information according to the rating of the borrower.

(10)

In the server device according to any one of the above (1) to (9), the provision unit provides, to the first terminal device, an attribute information input unit that prompts input of the attribute information, and the generation unit generates the one or more pieces of interest rate information on the basis of the attribute information input to the attribute information input unit.

(11)

In the server device according to any one of the above (1) to (10), the rating is calculated on the basis of a model generated by means of machine learning using a plurality of pieces of the attribute information.

(12)

In the server device according to the above (11), the provision unit provides, to the first terminal device, an attribute information input unit that prompts input of the attribute information, and the generation unit further uses, for machine learning, the attribute information input to the attribute information input unit to generate the model.

(13)

The server device according to any one of the above (1) to (12) further includes a storage unit that stores an application program configured to cause a terminal device to implement at least one of a function of causing the provision unit to make provision to the first terminal device or a function of causing the provision unit to make provision to the second terminal device, and the presentation unit is configured on the terminal device by the application program running on the terminal device, the application program being transmitted to the terminal device in advance.

(14)

The server device according to any one of the above (1) to (12) further includes a storage unit that stores an application program configured to cause a terminal device to implement at least one of a function of causing the provision unit to make provision to the first terminal device or a function of causing the provision unit to make provision to the second terminal device, and the presentation unit is configured on the terminal device by the application program loaded onto a browser application installed on the terminal device and executed on the browser application, the application program being transmitted to the terminal device.

(15)

A terminal device includes a communication unit that communicates with a server device including a generation unit that generates one or more pieces of interest rate information using a rating of a borrower as an individual, the rating being calculated on the basis of attribute information of the borrower, a display control unit that generates a screen to be displayed on a display unit, and an input unit that receives input according to the screen, and the display control unit generates the screen on the basis of the rating received from the server device via communications of the communication unit.

(16)

In the terminal device according to the above (15), the display control unit causes the screen to display the one or more pieces of interest rate information received from the server device via communications of the communication unit, and the communication unit transmits, to the server device, interest rate information selected from among the one or more pieces of interest rate information in accordance with input to the input unit according to the display of the screen.

(17)

In the terminal device according to the above (15) or (16), the display control unit causes the display unit to display a communication screen on which communications with the borrower are performed, and further causes the display unit to display an interest rate input unit configured to input the interest rate information via the communications.

(18)

In the terminal device according to the above (15) to (17), the display control unit causes the display unit to display a screen that presents one or more pieces of insurance information acquired according to the rating and transmitted from the server device.

(19)

In the server device according to the above (15) to (18), the display control unit causes the display unit to display the screen including at least information that is included in the attribute information and makes the borrower identifiable and the rating that is associated with the attribute information.

(20)

In the terminal device according to the above (15) to (19), the display control unit causes the display unit to display a screen prompting a designation of whether or not to accept interest rate information transmitted from the terminal device of the lender via the server device.

(21)

In the terminal device according to any one of the above (15) to (20), the display control unit causes the display unit to display the screen including information indicating the number of pieces of collateral according to the rating, the information being transmitted from the server device.

(22)

In the terminal device according to the above (21), the display control unit causes the display unit to display the screen including electronic collateral information indicating the collateral.

(23)

In the terminal device according to any one of the above (15) to (22), the communication unit, the display control unit, and the input unit are implemented by an application program installed on the terminal device and executed on a processor included in the terminal device.

In the terminal device according to any one of the above (15) to (22), the communication unit, the display control unit, and the input unit are implemented by an application program loaded onto a browser application installed on the terminal device and executed on the browser application, the application program being transmitted to the server device.

(25)

An information processing program causes a computer to execute a calculation step of calculating a rating of a borrower as an individual on the basis of attribute information of the borrower and a model created by means of machine learning using a plurality of pieces of the attribute information, and a presentation step of presenting information based on the rating to at least a second terminal device operated by a lender for the borrower out of a first terminal device operated by the borrower and the second terminal device.

(26)

An information processing program causes a computer to execute a communication step of communicating with a server device including a generation unit that performs generation using a rating of a borrower as an individual, the rating being calculated on the basis of attribute information of the borrower, and on the basis of a model created by means of machine learning using a plurality of the attribute information, a display control step of generating a screen to be displayed on a display unit, and an input step of receiving input according to the screen, and, in the display control step, the screen is generated on the basis of the rating received from the server device via communications in the communication step.

An information processing program executed by a processor includes a generation step of generating one or more pieces of interest rate information using a rating of a borrower as an individual, the rating being calculated on the basis of attribute information of the borrower, and a provision step of providing the one or more pieces of interest rate information to at least a second terminal device operated by a lender for the borrower out of a first terminal device operated by the borrower and the second terminal device, and provides interest rate information selected from among the one or more pieces of interest rate information in the second terminal device to the first terminal device.

(28)

An information processing method executed by a processor includes a communication step of communicating with a server device including a generation unit that generates one or more pieces of interest rate information using a rating of a borrower as an individual, the rating being calculated on a basis of attribute information of the borrower, a display control step of generating a screen to be displayed on a display unit, and an input step of receiving input according to the screen, and, in the display control step, the screen is generated on a basis of the rating received from the server device via communications in the communication step.

### REFERENCE SIGNS LIST

1 Information processing system
2 Network
10a, 10b Server device
20a, 20b, 30a, 30b Terminal device
40a, 40b Insurance company
100 Scoring model unit
101 Learning unit
102 Model data storage unit
103 Lender information storage unit
107 App storage unit
108 Web app unit
200 Application unit
210, 240 UI control unit
211, 241 Display information generation unit
212, 242 Input reception unit
213, 243 Communication control unit
214, 244 Information acquisition unit
220 Browser unit
230 Web app
300, 330 Attribute information
301, 331 Personal attribute information
302, 332 Repayment period information
303, 333 SNS/mobile application data
304, 334 Web cookie
310 Preprocessing
311 Training data
312 Test data
313 Machine learning model creation
314 Model evaluation
320 Customer scoring model
340 Score display
500 Agreement screen
510 Customer attribute input screen
520 Amount and repayment period input screen
530 Scoring screen
550 Standby screen
560 Collateral input screen
600 Borrower confirmation screen
610 Interest rate selection screen
620 Interest rate information input screen
630 Collateral confirmation screen
640 Insurance application determination screen
650 Insurance selection screen
660 Insurance detail display screen
670 Chat screen
5500 Lender selection screen

1. A server device comprising:
a generation unit that generates one or more pieces of interest rate information using a rating of a borrower as an individual, the rating being calculated on a basis of attribute information of the borrower; and
a provision unit that provides the one or more pieces of interest rate information to at least a second terminal device operated by a lender for the borrower out of a first terminal device operated by the borrower and the second terminal device, and provides interest rate information selected from among the one or more pieces of interest rate information in the second terminal device to the first terminal device.

2. The server device according to claim 1, wherein
the provision unit further provides, to the first terminal device and the second terminal device, information regarding a communication screen on which the borrower and the lender communicate with each other, and provides information regarding an interest rate input unit configured to input interest rate information to the second terminal device in accordance with an instruction from the second terminal device.

3. The server device according to claim 1, wherein
the provision unit provides, to the first terminal device, a message prompting a designation of whether or not to accept the interest rate information presented from the second terminal device.

4. The server device according to claim 1, wherein
the provision unit presents, to the second terminal device, at least information that is included in the attribute information and makes the borrower identifiable and the rating that is associated with the attribute information on one screen.

5. The server device according to claim 1, wherein
the provision unit requests the first terminal device to present a number of pieces of collateral according to the rating of the borrower.

6. The server device according to claim 5, wherein
the provision unit provides, to the second terminal device, a message prompting a designation of whether or not to agree to accept the collateral presented from the first terminal device in response to the request to present the collateral.

7. The server device according to claim 5, wherein
the provision unit requests the first terminal device to present, as the collateral, electronic collateral information that is made unusable by the borrower in a case where the borrower defaults on a loan.

8. The server device according to claim 7, wherein
in a case where the collateral of the borrower presented from the first terminal device has been successfully confirmed, the provision unit makes the electronic collateral information applicable as the collateral.

9. The server device according to claim 1, wherein
the provision unit provides, to the second terminal device, one or more pieces of insurance information according to the rating of the borrower.

10. The server device according to claim 1, wherein the provision unit provides, to the first terminal device, an attribute information input unit that prompts input of the attribute information, and
the generation unit generates the one or more pieces of interest rate information on a basis of the attribute information input to the attribute information input unit.

11. The server device according to claim 1, wherein the rating is calculated on a basis of a model generated by means of machine learning using a plurality of pieces of the attribute information.

12. The server device according to claim 11, wherein the provision unit provides, to the first terminal device, an attribute information input unit that prompts input of the attribute information, and
the generation unit further uses, for machine learning, the attribute information input to the attribute information input unit to generate the model.

13. The server device according to claim 1, further comprising a storage unit that stores an application program configured to cause a terminal device to implement at least one of a function of causing the provision unit to make provision to the first terminal device or a function of causing the provision unit to make provision to the second terminal device, wherein
the provision unit is configured on the terminal device by the application program running on the terminal device, the application program being transmitted to the terminal device in advance.

14. The server device according to claim 1, further comprising
a storage unit that stores an application program configured to cause a terminal device to implement at least one of a function of causing the provision unit to make provision to the first terminal device or a function of causing the provision unit to make provision to the second terminal device, wherein
the provision unit is configured on the terminal device by the application program loaded onto a browser application installed on the terminal device and executed on the browser application, the application program being transmitted to the terminal device.

15. A terminal device comprising:
a communication unit that communicates with a server device including a generation unit that generates one or more pieces of interest rate information using a rating of a borrower as an individual, the rating being calculated on a basis of attribute information of the borrower;
a display control unit that generates a screen to be displayed on a display unit; and
an input unit that receives input according to the screen, wherein
the display control unit generates the screen on a basis of the rating received from the server device via communications of the communication unit.

16. The terminal device according to claim 15, wherein
the display control unit causes the screen to display the one or more pieces of interest rate information received from the server device via communications of the communication unit, and
the communication unit transmits, to a terminal device of the borrower, interest rate information selected from among the one or more pieces of interest rate information in accordance with input to the input unit according to the display of the screen.

17. The terminal device according to claim 15, wherein
the display control unit causes the display unit to display a screen that presents one or more pieces of insurance information acquired according to the rating and transmitted from the server device.

18. The terminal device according to claim 15, wherein
the display control unit causes the display unit to display the screen including at least information that is included in the attribute information and makes the borrower identifiable and the rating that is associated with the attribute information.

19. An information processing program causing a computer to execute:
a communication step of communicating with a server device including a generation unit that generates one or more pieces of interest rate information using a rating of a borrower as an individual, the rating being calculated on a basis of attribute information of the borrower;
a display control step of generating a screen to be displayed on a display unit; and
an input step of receiving input according to the screen, wherein
in the display control step, the screen is generated on a basis of the rating received from the server device via communications in the communication step.

20. An information processing method executed by a processor, the information processing method comprising:
a communication step of communicating with a server device including a generation unit that generates one or more pieces of interest rate information using a rating of a borrower as an individual, the rating being calculated on a basis of attribute information of the borrower;
a display control step of generating a screen to be displayed on a display unit; and
an input step of receiving input according to the screen, wherein
in the display control step, the screen is generated on a basis of the rating received from the server device via communications in the communication step.
